(19) United States
(12) Patent Application Publication
(10) Pub. No.: US 2025/0265400 A1
(43) Pub. Date: Aug. 21, 2025

(54) DATA SELECTION METHOD, SYSTEM AND APPARATUS FOR EXTRACTING PARAMETERS FROM INTEGRATED CIRCUIT DEVICE MODEL

(71) Applicant: PRIMARIUS TECHNOLOGIES CO., LTD., Shanghai (CN)

(72) Inventors: Kai SHI, Shanghai (CN); Hancheng LIANG, Shanghai (CN)

(21) Appl. No.: 18/860,979

(22) PCT Filed: Dec. 28, 2022
(86) PCT No.: PCT/CN2022/142571

§ 371 Date: Oct. 28, 2024

(30) Foreign Application Priority Data
Apr. 29, 2022 (CN) 202210476110.X

(51) Int. Cl. G06F 30/333; G06F 119/02

(52) U.S. Cl. CPC G06F 30/333; G06F 2119/02

(57) ABSTRACT

A data selection method (and system and apparatus) for extracting parameters from an integrated circuit device model includes receiving a test dataset of an integrated circuit device; configuring at least three different filtering conditions, and setting bias attributes for each filtering condition; filling the filtering conditions and the bias attributes in the form of labels to generate a mapping form; performing primary fixed filtering classification on a plurality of test data according to the filtering conditions, and then performing secondary customized filtering by utilizing the bias attributes; mapping filtering results to corresponding labels in the mapping form; constructing association relationships of the customized test data in different filtering results; storing the customized test data screened each time in the form of a set; fitting a device model of the integrated circuit device to perform condition instantiation; and adjusting the bias attributes to realize the purpose of data selection.

### TECHNICAL FIELD

The present invention relates to the technical field of computer-aided design of integrated circuits, in particular to a data selection method, system and apparatus for extracting parameters from an integrated circuit device model.

### TECHNICAL BACKGROUND

The continuous development of semiconductor and integrated circuit technologies has made the importance of a computer-aided design (CAD) or electronic design automation (EDA) platform for integrated circuits increasingly important. One of the basic functions of the EDA platform is the parameter extraction from a device model. That is, model parameters of a semiconductor device manufactured in a specific integrated circuit manufacturing process are extracted on the basis of some standard device models. After the model parameters are extracted, various operating characteristics of the semiconductor device may be mathematically depicted in combination with the corresponding standard device model for device simulation in the subsequent circuit design.

A BSIM model is a metal oxide field-effect transistor (MOSFET) model developed by the University of California, Berkeley, United States, which is suitable for the design and simulation of digital and analog circuits. In the actual parameter extraction operation, test data of the MOSFET device (e.g., I-V curves and C-V curves of different sizes of MOSFET devices) may be processed by selecting various BSIM models (e.g., BSIM4, BSIM-Bulk and BSIM-CMG) corresponding to the actual MOSFET devices, and then, the model parameters of the MOSFET device may be extracted.

The existing technical solution for extracting device model parameters from an integrated circuit device has been disclosed to overcome the defect that a lot of time and computing resources are consumed for processing a large amount of test data during model parameter extraction, thereby improving the accuracy of model parameters. However, during practical applications, it is found that this technical solution is one of the key links in a parameter extraction process strategy of an integrated circuit device model because behavior regions reflected by device data are accurately divided and selected through analysis. However, according to the links and strategies of different extraction processes, there will be many flexible bias condition setting requirements for the test data. In order to avoid the increase in the amount of computation caused by repeatedly performing the data extraction step, a reusable data selection method will be required to implement a process strategy for extracting parameters from a device model, so it is necessary to improve the data selection for extracting parameters from an integrated circuit device model.

### SUMMARY OF THE INVENTION

The embodiments of the present application disclose a data selection method, system and apparatus for extracting parameters from an integrated circuit device model, which solve the problem that a data extraction step is repeatedly performed according to bias condition setting requirements in the process of extracting parameters from a device model in the prior art, and implement the fitting of the device model through customized test datasets, which achieve different filtering results directly, by adjusting bias attributes in a mapping form whiling performing the fitting operation on the device model according to the pre-configured mapping form with the bias attributes, thereby avoiding the repeated extraction of data.

According to a first aspect, an embodiment of the present application provides a data selection method for extracting parameters from an integrated circuit device model. The method includes:
receiving a test dataset of an integrated circuit device, the test dataset including a plurality of test data obtained by testing the integrated circuit device under different test conditions;
configuring at least three different filtering conditions through a user-defined condition filtering setting interface in response to a visualized operation interface being configured with the condition filtering setting interface, and setting a plurality of bias attributes for each filtering condition: filling the filtering conditions and the bias attributes in the form of labels to generate a mapping form;
after acquiring the test data in response to the pre-configuration of a database, performing a primary fixed filtering classification on the plurality of test data according to the filtering conditions, then performing secondary customized filtering by using the bias attributes, mapping filtering results to the corresponding labels in the mapping form, constructing association relationships of the customized test data in different filtering results, and storing the customized test data screened each time in the form of a set; and
fitting a device model of the integrated circuit device by using the customized test dataset, performing condition instantiation on the customized test data according to the association relationships, and adjusting the bias attributes to realize the purpose of selecting the customized test data.

Further, after the filtering conditions and the bias attributes are filled in the form of labels to generate the mapping form, a bias selection template is generated by forming condition variables based on the bias attributes entered or selected by a user, so that the bias attributes may be adjusted in a customized manner in response to the condition instantiation of the customized test data being performed.

Further, in the mapping form, different labels correspond to different filtering conditions and different bias attributes.

Further, in the course of fitting the device model, the device model maps two-dimensional fitting of any two screened customized test datasets and three-dimensional fitting of three or more screened customized test datasets in the visualized operation interface.

Further, the condition filtering setting interface includes fixedly-configured extraction condition fields, so that one filtering condition is correspondingly set through each extraction condition field in response to the user entry being received.

Further, each of the filtering conditions in the condition filtering setting interface includes a plurality of bias condition regions, and one bias attribute is correspondingly set for each bias condition region.

Further, in response to the user entry being received, at least one of the plurality of bias condition regions is selected for the bias condition variable in the bias attribute to be set or selected.

According to a second aspect, an embodiment of the present application provides a data selection system for extracting parameters from an integrated circuit device model, which adopts the method according to any item in the first aspect. The system includes:
a data receiving module, configured to receive a test dataset of an integrated circuit device, the test dataset including a plurality of test data obtained by testing the integrated circuit device under different test conditions;
a form generation module, configured to configure at least three different filtering conditions through a user-defined condition filtering setting interface in response to a visualized operation interface being configured with the condition filtering setting interface, and set a plurality of bias attributes for each filtering condition; and fill
the filtering conditions and the bias attributes in the form of labels to generate a mapping form;
a data filtering module, configured to, after acquiring the test data in response to the pre-configuration of a database, perform a primary fixed filtering classification on the plurality of test data according to the filtering conditions. then perform secondary customized filtering by using the bias attributes, map filtering results to the corresponding labels in the mapping form, construct association relationships of the customized test data in different filtering results, and store the customized test data screened each time in the form of a set; and
a model fitting module, configured to fit a device model of the integrated circuit device by using the customized test dataset, perform condition instantiation on the customized test data according to the association relationships, and adjust the bias attributes to realize the purpose of selecting the customized test data.

According to a third aspect, an embodiment of the present application provides a data selection apparatus for extracting parameters from an integrated circuit device model. The apparatus includes a non-transient computer storage medium having one or more executable instructions stored thereon, the one or more executable instructions being executed by a processor to perform the method according to any item in the first aspect. The technical solutions provided in the embodiments of the present application have at least the following technical effects.

Since the user-defined condition filtering setting interface is adopted to construct the mapping form, in the case of forming a fixed filtering condition, the bias attributes can be dynamically set and used in the generated mapping form, and the customized test datasets with different bias requirements can be acquired by simply adjusting the bias attributes, so as to fit the device model, thereby completing the data selection for extracting parameters. By customizing the bias attributes in the mapping form, the flexible selection of bias conditions on an interface and the reusability of the bias conditions are realized, and the complexity of process settings is not increased while the flexibility in the selection of the bias conditions is maintained.

### BRIEF DESCRIPTION OF THE DRAWINGS

FIG. 1 is a flowchart of a data selection method for extracting parameters from an integrated circuit device model in Embodiment 1 of the present application;

FIG. 2 is a user-defined condition filtering setting interface in Embodiment 1 of the present application;

FIG. 3 is a filtering condition setting interface in Embodiment 1 of the present application;

FIG. 4 is a bias attribute setting interface in Embodiment 1 of the present application;

FIG. 5 is a schematic interface of bias attribute setting in Embodiment 1 of the present application;

FIG. 6 is a two-dimensional fitting curve graph corresponding to bias attributes in FIG. 5;

FIG. 7 is a schematic interface of bias attribute adjustment in Embodiment 1 of the present application;

FIG. 8 is a comparison diagram of two-dimensional fitting curves corresponding to FIG. 6 and FIG. 7; and

FIG. 9 is a module diagram of a data selection system for extracting parameters from an integrated circuit device model in Embodiment 2 of the present application.

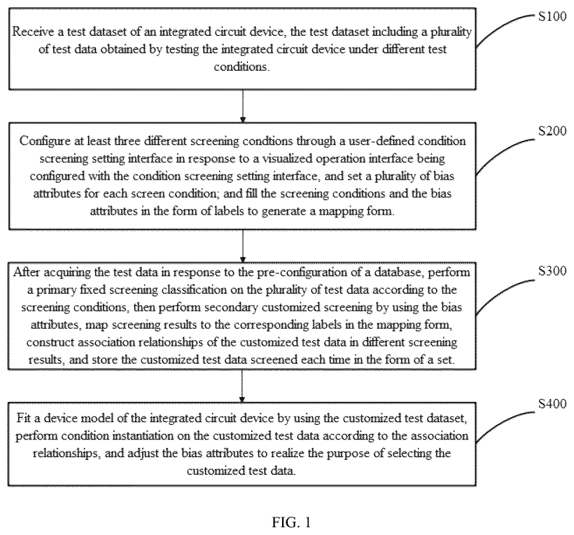

### DETAILED DESCRIPTION OF THE INVENTION

In the detailed description below, reference is made to the accompanying drawings that form part of the description. In the accompanying drawings, similar symbols usually denote similar components, unless the context otherwise indicated. The illustrative embodiments described in the detailed description, accompanying drawings and claims are not intended for a limitative purpose. Without deviating from the spirit or scope of the subject of the present application, other embodiments may also be adopted and other changes may be made. It may be understood that various aspects in the summary of the present application that are generally described in the present application and illustrated in the accompanying drawings may be configured, replaced, combined, and designed in a variety of different compositions, all of which expressly form part of the summary of the present application.

Since the parameter extraction process of a device model of an integrated circuit device is performed by each integrated circuit manufacturing company according to an integrated circuit manufacturing process that it can provide, so it can be known that the actual performance of the integrated circuit device depends on the corresponding integrated circuit manufacturing process. However, different operators will perform differentiated parameter extraction operations based on factors such as personal work experience, software usage habits, and company-defined parameter extraction requirements.

Therefore, in order to better understand the above-mentioned technical solutions, the above-mentioned technical solutions will be described in detail below in conjunction with the accompanying drawings of the specification and the specific embodiments.

### Embodiment 1

The present embodiment of the present application provides a data selection method for extracting parameters from an integrated circuit device model. Through this method, an operator is assisted to add a parameter extraction condition setting function to parameter extraction software that executes the device model, and set a bias design in this function to perform a filtering purpose according to different bias requirements.

The method includes the following steps.

Step S100: receive a test dataset of an integrated circuit device, the test dataset including a plurality of test data obtained by testing the integrated circuit device under different test conditions. The test data includes, but is not limited to, a current, a voltage, and a capacitance.

Step S200: configure at least three different filtering conditions through a user-defined condition filtering setting interface in response to a visualized operation interface being configured with the condition filtering setting interface, and set a plurality of bias attributes for each filtering condition: fill the filtering conditions and the bias attributes in the form of labels to generate a mapping form.

Step S300: after acquiring the test data in response to the pre-configuration of a database, perform a primary fixed filtering classification on the plurality of test data according to the filtering conditions, then perform secondary customized filtering by using the bias attributes, map filtering results to the corresponding labels in the mapping form, construct association relationships of the customized test data in different filtering results, and store the customized test data screened each time in the form of a set.

Step S400: fit a device model of the integrated circuit device by using the customized test dataset, perform condition instantiation on the customized test data according to the association relationships, and adjust the bias attributes to realize the purpose of selecting the customized test data.

It is further supplemented that the data selection method provided in the present embodiment is designed on the premise of parameter extraction from the integrated circuit device model. That is, the integrated circuit device model needs to be determined in advance before the data selection in parameters extracted from the model is considered, so that the selected data can be used for various integrated circuit devices and the corresponding models. In some embodiments, the integrated circuit devices may be, but are not limited to, the following devices: a MOSFET transistor, a silicon-on-insulator transistor (SOI), a fin-type field-effect transistor (FinFET), a bipolar transistor (BJT), a heterojunction bipolar transistor (HBT), a thin-film transistor (TFT), a metal semiconductor field-effect transistor (MESFET), a diode, a resistor or an inductor, etc. The determined device model may be, but is not limited to, BSIM3, BSIM4, BSIM6, BSIM-CMG, BSIM-IMG, BSIMSOI, UTSOI, HiSIM2, HiSIM_HV, PSP, GP-BJT, or RPITFT. For example, for the MOSFET transistor, the corresponding device model may be BSIM3, BSIM4, BSIM6, or other known standard or non-standard models. It may be understood that the above device models are only illustrative, and in practical applications, the model corresponding to the integrated circuit device can be selected according to needs. The MOSFET transistor is one of the most commonly used devices in integrated circuits, so the integrated circuit device in the present embodiment is described with the MOSFET transistor as an example. However, a person skilled in the art may understand that the application of the present application is not limited to this.

After the applicable device model is selected and determined, in order to extract model parameters, it is also necessary to provide test data corresponding to the integrated circuit device, and the test data may be obtained by testing the integrated circuit device under different test conditions. The various test conditions in the present embodiment may be combined into new test conditions. For example, the test conditions may be different sizes (e.g., different channel lengths and channel widths), different voltage bias conditions (e.g., a bias voltage Vbs between a body region and a source. different source and drain voltages Vds), and different temperature conditions of the integrated circuit devices, etc. Different types of test conditions may be combined into a new set of test conditions that are used to describe physical characteristics and test environment of the integrated circuit device under test, such as a channel length, width, and body bias voltage of the device. It should be noted that the integrated circuit device in the present embodiment does not refer to a specific physical device, but refers to a general term for a class of devices manufactured by the same integrated circuit manufacturing process. For example, two integrated circuit devices that are manufactured by the same manufacturing process but differ only in the channel width may be considered to be the same integrated circuit device.

Therefore, the integrated circuit device may be tested under each set of test conditions to produce corresponding test data, which may be one or more of a current, a voltage, a capacitance, or other derived electrical parameters. Therefore, the test data obtained by testing under a plurality of sets of test conditions can constitute a test dataset. In some other embodiments. the test data may be changed or adjusted according to the test conditions and test requirements at the time of testing, but the present application is not limited thereto. For example, the derived electrical parameters may include parameters such as Idin, saturation leakage current Idsat, maximum transconductance maxGm, Vtlin, saturation threshold voltage Vtsat, and Vtgm, or may also include electrical output parameters such as Gm and Gds. More information on these parameters may refer to the descriptions in a BSIM model or other models. These electrical parameters may vary with voltage.

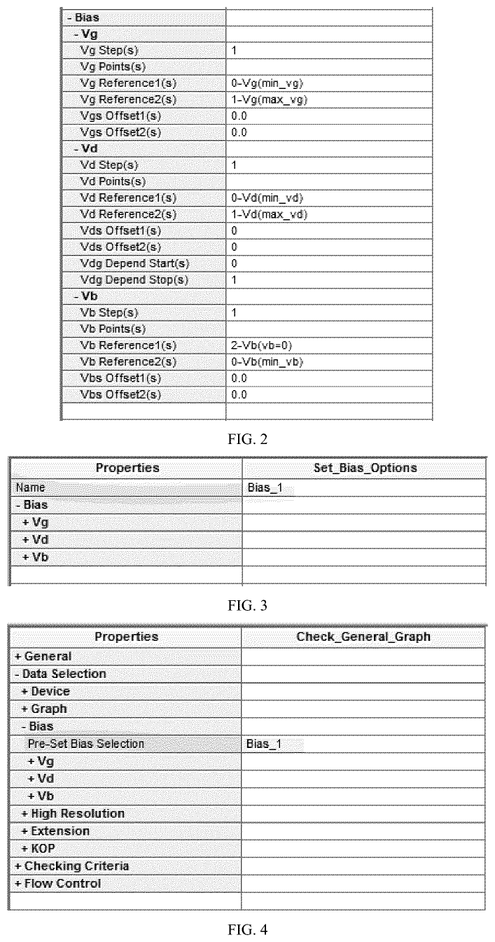

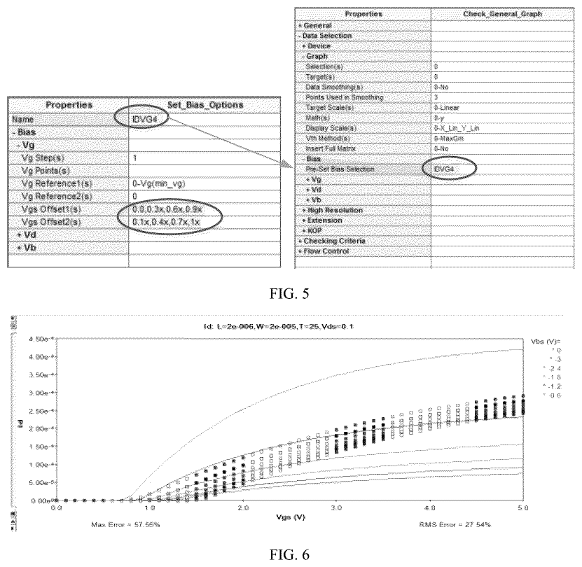

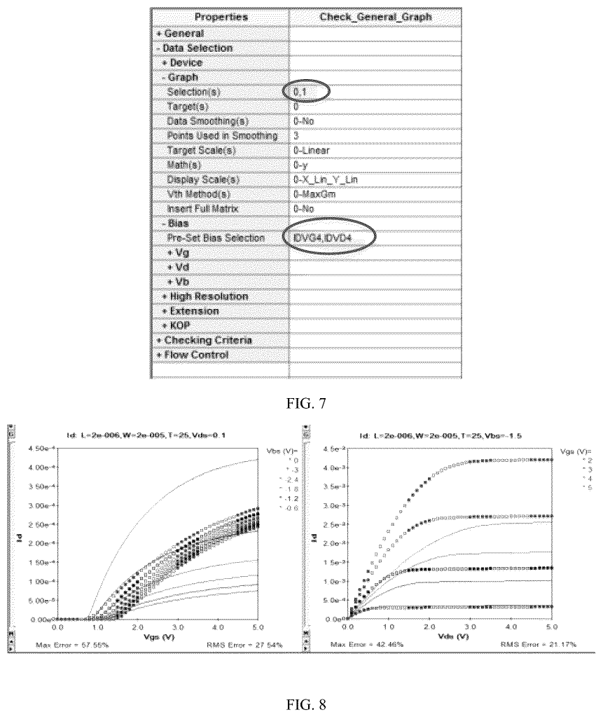

Referring to FIGS. 2-8, after the filtering conditions and the bias attributes in the present embodiment are filled in the form of labels to generate the mapping form, a bias selection template is generated by forming condition variables based on bias attributes entered or selected by a user, so that the bias attributes can be adjusted in a customized manner in the event of performing the condition instantiation on the customized test data. In addition, in the mapping form, different labels correspond to different filtering conditions and different bias attributes, and one filtering condition may be configured with a plurality of different bias attributes.

The condition filtering setting interface in the present embodiment includes fixedly-configured extraction condition fields, so that one filtering condition is correspondingly set through each extraction condition field in response to the user entry being received. Each filtering condition in the condition filtering setting interface includes a plurality of bias condition regions, and one bias attribute is set correspondingly for each bias condition region. In response to the user entry being received, at least one of the plurality of bias condition regions is selected for a bias condition variable in the bias attribute to be set or selected.

After the fixedly-configured filtering condition is given in the present embodiment. the bias attributes are set. For example, the fixed filtering condition is a type of test data. For example, the test data in the test dataset is divided according to the data type, so that the test data is classified and screened for the first time through the filtering condition, and then different bias attributes are screened and divided again for different types of test data. In the case that the filtering condition in the present embodiment is a data type, the filtering condition may be a current, a voltage, a capacitance or other types. The bias attributes may be based on different types of bias selections, such as step, points, reference, offset, etc.

In the present embodiment, the user-defined condition filtering setting interface is adopted. That is to say, in the course of initial setting, both the filtering conditions and the bias attributes are customized, so that the bias attributes can be dynamically updated after the configuration of the fixed filtering condition is completed. Therefore, the bias conditions can be adjusted according to needs, so as to realize the flexible selection of the bias conditions, thereby flexibly providing a plurality of types of bias setting-related options for a port of each integrated circuit device. Therefore, it can be seen that the purpose of data selection can be achieved by flexibly adjusting the bias attributes, so as to meet the test data acquisition for more bias requirements and reduce the difficulty of the operator in the bias selection operation.

In the present embodiment, the received test data is screened fixedly once by using the filtering conditions, which is equivalent to the filtering conditions in the mapping form being fixed after the first completion of the customized configuration, but the filtering conditions remain unchanged regardless of how the bias attributes change. Further, the data selection is performed by using different bias attribute settings. In the present embodiment, a voltage bias is adopted. Therefore, the bias condition in the bias attribute is a voltage bias condition. In the accompanying drawings, Vg, Vd, and Vb refer to a device gate voltage, a drain voltage, and a substrate pole voltage, respectively. In the bias attribute settings in the present embodiment, voltage bias region setting is also included. For example, when the device data is measured, a voltage scanning region/range is acquired. For example, assuming Vg1<Vg2, a voltage bias condition set [Vg1, Vg2] is taken as a voltage bias region. The bias attributes further include a bias option for the user to set the bias condition (voltage bias condition). The bias attributes further include bias selection, so the operator can set and select the appropriate bias condition (voltage bias condition) according to his or her own habit/strategy by means of the bias option. A plurality of customized test datasets is acquired on the basis of the fixed filtering condition, and the filtering condition is adapted to the fitting operation of the device model. In the course of fitting the device model, the device model maps two-dimensional fitting of any two screened customized test datasets and three-dimensional fitting of three or more screened customized test datasets in the visualized operation interface. Because the condition instantiation is implemented for the data in the customized test dataset through the correlation relationships, the operator can screen out a set of data that meets test requirements according to a fitting effect. In addition, according to the data selection method for extracting parameters from the integrated circuit device model provided in the present application, it can be seen that before performing the calculation process for extracting the parameters from the device model, the operator configures the filtering conditions and bias attributes through the user-defined condition filtering setting interface, and completes the data fitting of the device model in at least three dimensions through at least three different filtering conditions. Of course, a two-dimensional fitting curve is acquired directly in the presence of two filtering conditions. The operator may select or set various filtering conditions for parameter extraction, and save a set of the selected or set filtering conditions. Then, different bias attributes are adjusted according to the fixed filtering condition, in order to select data with different bias requirements. Similarly, after one data selection operation is performed once, if the operator wants to continue to use the same filtering condition, he/she can call the previous filtering condition before performing the next operation: and when different operators want to uniformly adopt a parameter extraction process, they only need to acquire a set of pre-saved parameter extraction conditions, so that the standardization and reusability of the parameter extraction process are possible, without reducing the flexibility of condition setting, so the operators can still adjust various conditions of parameter extraction according to personal needs.

### Embodiment 2

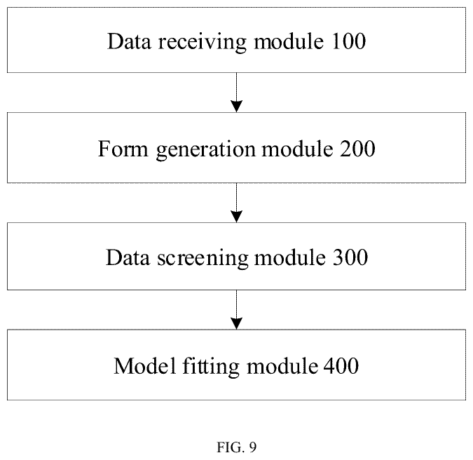

Referring to FIG. 9, the present embodiment of the present application provides a data selection system for extracting parameters from an integrated circuit device model, which adopts the method according to any item in Embodiment 1. The system includes the following modules:
a data receiving module 100, configured to receive a test dataset of an integrated circuit device, the test dataset including a plurality of test data obtained by testing the integrated circuit device under different test conditions;
a form generation module 200, configured to configure at least three different filtering conditions through a user-defined condition filtering setting interface in response to a visualized operation interface being configured with the condition filtering setting interface, and set a plurality of bias attributes for each filtering condition: and fill the filtering conditions and the bias attributes in the form of labels to generate a mapping form;
a data filtering module 300, configured to, after acquiring the test data in response to the pre-configuration of a database, perform a primary fixed filtering classification on the plurality of test data according to the filtering conditions, then perform secondary customized filtering by using the bias attributes, map filtering results to the corresponding labels in the mapping form, construct association relationships of the customized test data in different filtering results, and store the customized test data screened each time in the form of a set; and
a model fitting module 400, configured to fit a device model of the integrated circuit device by using the customized test dataset, perform condition instantiation on the customized test data according to the association relationships, and adjust the bias attributes to realize the purpose of selecting the customized test data.

### Embodiment 3

The present embodiment of the present application provides a data selection apparatus for extracting parameters from an integrated circuit device model. The apparatus includes a non-transient computer storage medium having one or more executable instructions stored thereon, the one or more executable instructions being executed by a processor to perform the following method steps in Embodiment 1.

Step S100: receive a test dataset of an integrated circuit device, the test dataset including a plurality of test data obtained by testing the integrated circuit device under different test conditions.

Step S200: configure at least three different filtering conditions through a user-defined condition filtering setting interface in response to a visualized operation interface being configured with the condition filtering setting interface, and set a plurality of bias attributes for each filtering condition: fill the filtering conditions and the bias attributes in the form of labels to generate a mapping form.

Step S300: after acquiring the test data in response to the pre-configuration of a database, perform a primary fixed filtering classification on the plurality of test data according to the filtering conditions, then perform secondary customized filtering by using the bias attributes, map filtering results to the corresponding labels in the mapping form, construct association relationships of the customized test data in different filtering results, and store the customized test data screened each time in the form of a set.

Step S400: fit a device model of the integrated circuit device by using the customized test dataset, perform condition instantiation on the customized test data according to the association relationships, and adjust the bias attributes to realize the purpose of selecting the customized test data.

It should be understood by a person skilled in the art that the embodiments of the present application may be provided as methods, systems, or computer program products. Therefore, the present application may adopt embodiments in the forms of full hardware, full software, or a combination of software and hardware. Furthermore, the present application may adopt forms of computer program products executed on one or more computer usable storage media (including but not being limited to a disk storage, a CD-ROM, an optical storage. etc.) containing computer usable program codes.

The present application is described with reference to the flowcharts and/or block diagrams of a method, a device (system), and a computer program product according to the embodiments of the present application. It should be understood that each process and/or block in the flowcharts and/or block diagrams, and combinations of processes and/or blocks in the flowcharts and/or block diagrams, may be realized by computer program instructions. These computer program instructions may be provided to a generate-purpose computer, a special-purpose computer, an embedded processor, or processors of other programmable data processing devices, to create a machine, such that an apparatus for realizing functions designated in one or more processes in the flowcharts and/or in one or more blocks in the block diagrams, may be created by instructions performed by a computer or processors of other programmable data processing devices.

These computer program instructions may further be stored in a computer readable storage that can guide a computer or other programmable data processing devices to work in a specific way, such that a manufactured product including an instruction apparatus may be created by the instructions stored in this computer readable storage, and this instruction apparatus realizes the functions designated in one or more processes in the flowcharts and/or in one or more blocks in the block diagrams.

These computer program instructions may further be loaded into a computer or other programmable data processing devices, such that a series of operating steps may be performed on the computer or other programmable data processing devices, so as to generate processes realized by the computer, such that steps for realizing the functions designated in one or more processes in the flowcharts and/or in one or more blocks in the block diagrams may be provided by the instructions executed on the computer or other programmable data processing devices.

Although preferred embodiments of the present application have been described, those embodiments may be changed or modified additionally once the basic inventive concepts are known to those skilled in the art. Therefore, the attached claims are intended to be construed to include the preferred embodiments and all changes and modifications that fall within the scope of the present application.

Obviously, a person skilled in the art may make various alterations and variations to the present application without departing from the spirit and scope of the present application. Thus, if these modifications and variants of the present application fall within the scope of the claims of the present invention and its equivalents, the present application is also intended to include such alterations and variants.

1. A data selection method for extracting parameters from an integrated circuit device model, the method comprising:
receiving a test dataset of an integrated circuit device, the test dataset comprising a plurality of test data obtained by testing the integrated circuit device under different test conditions;
configuring at least three different filtering conditions through a user-defined condition filtering setting interface in response to a visualized operation interface being configured with the condition filtering setting interface, and setting a plurality of bias attributes for each filtering condition; filling the filtering conditions and the bias attributes in the form of labels to generate a mapping form;
after acquiring the test data in response to the pre-configuration of a database, performing a primary fixed filtering classification on the plurality of test data according to the filtering conditions, then performing secondary customized filtering by using the bias attributes, mapping filtering results to the corresponding labels in the mapping form, constructing association relationships of the customized test data in different filtering results, and storing the customized test data screened each time in the form of a set; and
fitting a device model of the integrated circuit device by using the customized test dataset, performing condition instantiation on the customized test data according to the association relationships, and adjusting the bias attributes to realize the purpose of selecting the customized test data.

2. The data selection method for extracting parameters from the integrated circuit device model according to claim 1, wherein, after the filtering conditions and the bias attributes are filled in the form of labels to generate the mapping form, a bias selection template is generated by forming condition variables based on the bias attributes entered or selected by a user, so that the bias attributes are adjusted in a customized manner in the course of performing the condition instantiation of the customized test data.

3. The data selection method for extracting parameters from the integrated circuit device model according to claim 1, wherein, in the mapping form, different labels correspond to different filtering conditions and different bias attributes.

4. The data selection method for extracting parameters from the integrated circuit device model according to claim 1, wherein, in the course of fitting the device model, the device model maps two-dimensional fitting of any two screened customized test datasets and three-dimensional fitting of three or more screened customized test datasets in the visualized operation interface.

5. The data selection method for extracting parameters from the integrated circuit device model according to claim 1, wherein the condition filtering setting interface comprises fixedly-configured extraction condition fields, so that one filtering condition is correspondingly set through each extraction condition field in response to the user entry being received.

6. The data selection method for extracting parameters from the integrated circuit device model according to claim 5, wherein each filtering condition in the condition filtering setting interface comprises a plurality of bias condition regions, and one bias attribute is set correspondingly for each bias condition region.

7. The data selection method for extracting parameters from the integrated circuit device model according to claim 6, wherein, in response to the user entry being received, at least one of the plurality of bias condition regions is selected for a bias condition variable in the bias attribute to be set or selected.

8. A data selection system for extracting parameters from an integrated circuit device model, adopting the method according to claim 1, wherein the system comprises:
a data receiving module, configured to receive a test dataset of an integrated circuit device, the test dataset comprising a plurality of test data obtained by testing the integrated circuit device under different test conditions;
a form generation module, configured to configure at least three different filtering conditions through a user-defined condition filtering setting interface in response to a visualized operation interface being configured with the condition filtering setting interface, and set a plurality of bias attributes for each filtering condition; and fill the filtering conditions and the bias attributes in the form of labels to generate a mapping form;
a data filtering module, configured to, after acquiring the test data in response to the pre-configuration of a database, perform a primary fixed filtering classification on the plurality of test data according to the filtering conditions, then perform secondary customized filtering by using the bias attributes, map filtering results to the corresponding labels in the mapping form, construct association relationships of the customized test data in different filtering results, and store the customized test data screened each time in the form of a set; and
a model fitting module, configured to fit a device model of the integrated circuit device by using the customized test dataset, perform condition instantiation on the customized test data according to the association relationships, and adjust the bias attributes to realize the purpose of selecting the customized test data.

9. A data selection apparatus for extracting parameters from an integrated circuit device model, the apparatus comprising a non-transient computer storage medium having one or more executable instructions stored thereon, the one or more executable instructions being executed by a processor to perform the method according to claim 1.
